(19) United States
(12) Patent Application Publication
(10) Pub. No.: US 2019/0295469 A1
(43) Pub. Date: Sep. 26, 2019

(54) DISPLAY DEVICE

(71) Applicant: Sharp Kabushiki Kaisha, Sakai City, Osaka (JP)

(72) Inventors: Seiji UMEZAWA, Sakai City (JP); Tamotsu SAKAI, Sakai City (JP)

(21) Appl. No.: 16/465,249

(22) PCT Filed: Aug. 1, 2017
(86) PCT No.: PCT/JP2017/027812

§ 371 Date: May 30, 2019

(51) Int. Cl. G09G 3/3241

(52) U.S. Cl. CPC G09G 3/3241; G09G 2310/0297; G09G 2300/0847

(57) ABSTRACT

The present application discloses that the potential of a node is promptly lowered to the initialization potential during the initialization period and an image having luminance corresponding to a data signal is displayed.

A boost capacitor including one terminal connected to a node and the other terminal connected to a previous scanning signal line is disposed. When a first initializing transistor is brought into an on state during the initialization period, and the node is connected to an initialization power source line, the node is lowered. Furthermore, since the level of the voltage applied to the second terminal of the boost capacitor charged during the previous scanning select period changes from a high level to a low level, the potential of the node is also lowered. Thus, the potential of the node decreases rapidly toward the initialization potential.

### TECHNICAL FIELD

The disclosure relates to a display device, and more specifically, relates to a display device including a display element driven by a current, such as an organic Electro Luminescence (EL) display device.

### BACKGROUND ART

As a thin display device with a high picture quality and a low power consumption, an organic EL display device is known. In the organic EL display device, a plurality of pixel circuits including an organic EL element (also referred to as an “Organic Light Emitting Diode”) being a self-luminous display element driven by a current and a driving transistor are arranged in a matrix shape.

FIG. 10 is a diagram illustrating a configuration of a known pixel circuit 111 described in PTL 1. As illustrated in FIG. 10, the pixel circuit 111 includes one organic EL element OLED, seven transistors M1 to M7, a storage capacitor Cst, and an auxiliary capacitor Cau. All of these transistors M1 to M7 are P-channel transistors. The transistor M1 is a driving transistor for controlling a current to be supplied to the organic EL element OLED. The transistor M2 is a writing transistor for writing a voltage corresponding to a data signal (data voltage) into the pixel circuit 111. The compensating transistor M3 is a compensating transistor for compensating for variations in the threshold voltage of the driving transistor M1. The variations cause luminance unevenness. The transistor M4 is a first initializing transistor for initializing the potential of a node N to which the gate terminal of the driving transistor M1 and one terminal of the below described storage capacitor Cst are connected, that is, a gate voltage Vg of the driving transistor M1. The transistor M5 is a power-supplying transistor for controlling the supply of a high level power source voltage ELVDD to the pixel circuit 111. The transistor M6 is a light emission control transistor for controlling the light emission period of the organic EL element OLED. The transistor M7 is a second initializing transistor for initializing the anode voltage of the organic EL element OLED.

The storage capacitor Cst is a capacitor that includes one terminal being connected to the gate terminal of the driving transistor M1 with the node N therebetween and the other terminal being connected to the high level power source line ELVDD, and the storage capacitor Cst holds electric charges corresponding to the voltage difference between the high level power source voltage ELVDD and the voltage applied to the gate terminal of the driving transistor M1 for one frame period. In the pixel circuit 111, a data signal line capacitor Cd being a parasitic capacitor of the data signal line D separated during the data period and the storage capacitor Cst are coupled to each other during the scanning select period. Thus, the electric charges corresponding to the data voltage held in the data signal line capacitor Cd are redistributed to the data signal line capacitor Cd and the storage capacitor Cst.

Next, before describing the auxiliary capacitor Cau, the problem in a case where the auxiliary capacitor Cau is not provided will be described. When a coupling between the data signal line capacitor Cd and the storage capacitor Cst during the scanning select period causes the electric charges corresponding to the data voltage held in the data signal line capacitor Cd to be redistributed to the data signal line capacitor Cd and the storage capacitor Cst, a voltage of a voltage value less than that of the data voltage held in the data signal line D is applied to the gate terminal of the driving transistor M1. Thus, the gate voltage Vg of the driving transistor corresponding to the black luminance decreases, and the drive current flowing through the organic EL element OLED increases only by the amount of the decrease in the gate voltage Vg when an image having black luminance is displayed, and this causes a problem that the contrast ratio of the image decreases.

Therefore, in PTL 1, as illustrated in FIG. 10, the auxiliary capacitor Cau is provided. One terminal of the auxiliary capacitor Cau is connected to the node N, and the other terminal thereof is connected to a scanning signal line Sj and the gate terminal of the writing transistor M2. When the voltage to be applied to the scanning signal line Sj changes from a low level to a high level, the potential of the node N, that is, the gate voltage Vg of the driving transistor M1 is pushed up by the auxiliary capacitor Cau charged with the data voltage and rises from the data voltage by the voltage difference between the low level voltage and the high level voltage applied to the scanning signal line Sj. Thus, the provided auxiliary capacitor Cau boosts the gate voltage Vg of the driving transistor M1 by the voltage difference so that it is possible to further reduce the drive current flowing through the organic EL element OLED when the black luminance is expressed. This makes it possible to display an image with black luminance and to improve the contrast ratio of the image.

### CITATION LIST

### Patent Literature

PTL 1: JP 2007-79580 A

### SUMMARY

### Technical Problem

In the organic EL display device illustrated in FIG. 10, before the data voltage is written into the node N, the first initializing transistor M4 disposed between an initialization power source line Vini and the storage capacitor Cst is turned into an on state, and the potential of the node N is lowered to the initialization potential Vini. Thus, the potential of the node N is initialized, and a data voltage corresponding to the data signal is written into the node N via the writing transistor M2 and the compensating transistor M3 during the scanning select period in which the potential of the scanning signal line Sj reaches a low level.

However, even in a case where the potential of a previous scanning signal line Sj−1 is set to a low level and the first initializing transistor M4 is turned into an on state in order that the potential of the node N is initialized during the initialization period, it takes time for the potential of the node N to decrease to the initialization potential Vini. Therefore, before the potential of the node N drops to the initialization potential Vini, the period may move from the data period to the scanning select period, and a data voltage may be written into the node N from the data signal line D via the writing transistor M2 and the compensating transistor M3. In this case, since a voltage value different from the data voltage is held in the storage capacitor Cst, the driving current of the organic EL element OLED controlled by the driving transistor M1 has a current value different from the current value corresponding to the data signal. Therefore, an image having luminance different from the luminance corresponding to the data signal is displayed.

Therefore, an object of the disclosure is to provide a display device capable of promptly lowering the potential of a node to an initialization potential during an initialization period to display an image having a luminance corresponding to a data signal.

### Solution to Problem

A display device according to an aspect of an embodiment of the disclosure is a display device including a plurality of data signal lines configured to transmit a plurality of data signals representing an image to be displayed, a plurality of scanning signal lines intersecting the plurality of data signal lines, and a plurality of pixel circuits arranged in a matrix shape along the plurality of data signal lines and the plurality of scanning signal lines, the display device including:

a data signal line driving circuit configured to output the plurality of data signals to the respective plurality of data signal lines; and

a scanning signal line driving circuit configured to selectively drive the plurality of scanning signal lines.

Each of the plurality of pixel circuits corresponds to any one of the plurality of data signal lines and corresponds to any one of the plurality of scanning signal lines.

Each of the plurality of pixel circuits includes a display element configured to be driven by a current, a holding capacitor configured to hold a voltage for controlling a drive current of the display element, a driving transistor configured to apply a drive current corresponding to a voltage held in the holding capacitor to the display element, and an initializing transistor configured to initialize a potential of a control terminal of the driving transistor, and each of the plurality of pixel circuits has a configuration in which in a case that a corresponding scanning signal line is in a select state, the driving transistor is brought into a diode connection state and a voltage of a corresponding data signal line is applied to the holding capacitor via the driving transistor, and in a case that a corresponding previous scanning signal line is in a select state, a potential of a control terminal of the driving transistor is initialized via the initializing transistor.

The holding capacitor includes a first holding capacitor including one terminal connected to a control terminal of the driving transistor and the other terminal connected to the previous scanning signal line.

### Advantageous Effects of Disclosure

According to the display device of the aspect, when the initializing transistor is brought into an on state during the initialization period, and not only the potential of the control terminal is initialized due to the control terminal of the driving transistor being connected to the initialization power source line but also the level of the voltage applied to the second terminal of the first holding capacitor changes from a high level to a low level, the potential of the control terminal is also lowered by the first holding capacitor. Thus, the potential of the control terminal of the driving transistor decreases in a short period toward the initialization potential. Therefore, the data voltage is written into the first holding capacitor in the scanning select period in which the scanning signal line is brought into a select state, and the organic EL display device can display an image having luminance corresponding to the data signal. In addition, since the first holding capacitor can hold the data voltage, it is unnecessary to newly provide a capacitor provided for holding the voltage in the related art. Thus, the configuration of the pixel circuits can be simplified, and the manufacturing cost of the display device can be reduced.

### BRIEF DESCRIPTION OF DRAWINGS

FIG. 1 is a block diagram illustrating an overall configuration of an organic EL display device according to a first embodiment of the disclosure.

FIG. 2 is a circuit diagram illustrating a connection relationship between a pixel circuit and various wiring lines included in an organic EL display device according to the first embodiment.

FIG. 3 is a diagram illustrating a positional relationship between a storage capacitor and a boost capacitor disposed in the respective pixel circuits illustrated in FIG. 2.

FIG. 4 is a timing chart for illustrating a driving method of each pixel circuit illustrated in FIG. 2.

FIG. 5 is a block diagram illustrating an overall configuration of an organic EL display device according to a modified example of the first embodiment.

FIG. 6 is a circuit diagram illustrating a configuration of a pixel circuit included in the organic EL display device according to the modified example illustrated in FIG. 5.

FIG. 7 is a timing chart for illustrating a driving method of the pixel circuit illustrated in FIG. 6.

FIG. 8 is a circuit diagram illustrating a connection relationship between a pixel circuit and various wiring lines included in an organic EL display device according to a second embodiment.

FIG. 9 is a circuit diagram illustrating a configuration of a pixel circuit included in an organic EL display device according to a modified example of the second embodiment.

FIG. 10 is a circuit diagram illustrating a configuration of a pixel circuit included in a known organic EL display device.

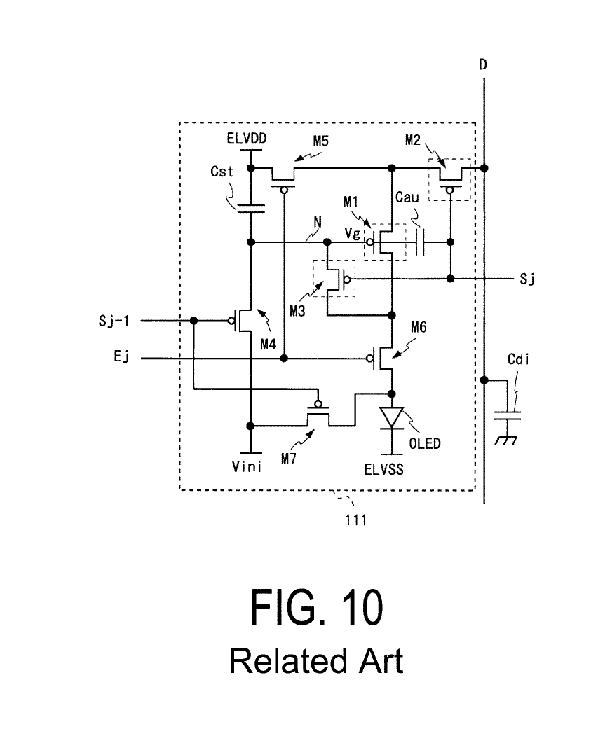

### DESCRIPTION OF EMBODIMENTS

In the following, each embodiment will be described with reference to the accompanying drawings. Note that in each of the transistors referred to below, the gate terminal corresponds to a control terminal, one of the drain terminal and the source terminal corresponds to a first conducting terminal, and the other corresponds to a second conducting terminal. In addition, all transistors in each embodiment are described as P-channel transistors, but the disclosure is not limited thereto, and the all transistors in each embodiment may be N-channel transistors. Furthermore, the transistor in each embodiment is, for example, a thin film transistor, but the disclosure is not limited thereto. Still further, the term “connection” used herein means “electrical connection” unless otherwise specified, and, without departing from the spirit and scope of the disclosure, the term includes not only a case in which a direct connection is meant but also a case in which an indirect connection with another element therebetween is meant.

### 1. Embodiment

### 1.1 Overall Configuration

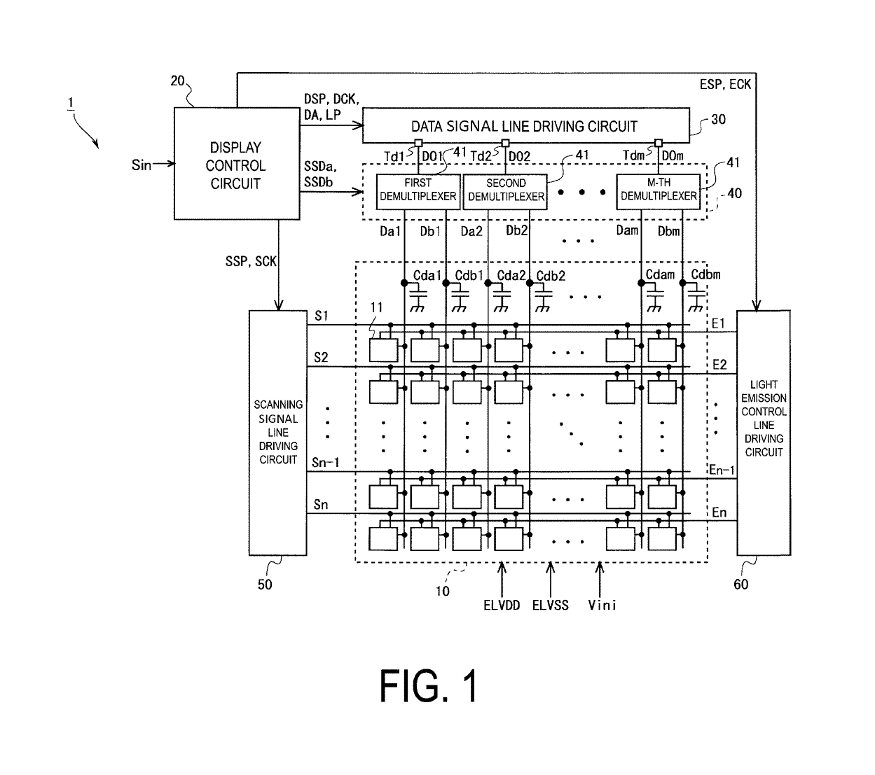

FIG. 1 is a block diagram illustrating an overall configuration of an organic EL display device 1 according to an embodiment of the disclosure. This organic EL display device 1 is an organic EL display device of the SSD system configured to perform internal compensation, and as illustrated in FIG. 1, includes a display portion 10, a display control circuit 20, a data signal line driving circuit 30, a demultiplexer unit (also referred to as “selection output circuit”) 40, a scanning signal line driving circuit 50, and a light emission control line driving circuit 60.

In the display portion 10, m×k (m and k are integers of 2 or more, and k is 2 in the present embodiment) data signal lines Da1, Db1, Da2, Db2, . . . , Dam, and Dbm; and n (n is an integer of 2 or more) scanning signal lines S1 to Sn intersecting these data signal lines are arranged, and n light emission control lines E1 to En are respectively arranged along the n scanning signal lines S1 to Sn. In addition, as illustrated in FIG. 1, the display portion 10 is provided with 2 m×n pixel circuits 11. These 2 m×n pixel circuits 11 are arranged in a matrix shape along the 2 m data signal lines Dx1 to Dxm (x=a, b) and the n scanning signal lines S1 to Sn in such a manner that each of these 2 m×n pixel circuits 11 corresponds to any one of the 2 m data signal lines Dx1 to Dxm (x=a, b) and also corresponds to any one of the n scanning signal lines S1 to Sn and any one of the n light emission control lines E1 to En. The 2 m data signal lines Dx1 to Dxm (x=a, b) are connected to the demultiplexer unit 40, the n scanning signal lines S1 to Sn are connected to the scanning signal line driving circuit 50, and the n light emission control lines E1 to En are connected to the light emission control line driving circuit 60.

In addition, in the display portion 10, a power source line common to each pixel circuit 11 (not illustrated) is provided. More specifically, a high level power source line ELVDD for supplying a high level power source voltage ELVDD for driving an organic EL element described below and a low level power source line ELVSS for supplying a low level power source voltage ELVSS for driving the organic EL element are provided. Furthermore, an initialization power source line Vini for supplying an initialization voltage Vini for an initialization action described below is provided. These voltages are supplied from a power source circuit (not illustrated).

In FIG. 1, data signal line capacitors Cda1 to Cdam respectively formed by the parasitic capacitors of the m data signal lines Da1 to Dam of the pixel circuits 11, and data signal line capacitors Cdb1 to Cdbm respectively formed by the parasitic capacitors of m data signal lines Db1 to Dbm of the pixel circuits are illustrated. A ground voltage is applied to one end that is not connected to a data signal line Dxi of each data signal line capacitor Cdxi, but the disclosure is not limited thereto.

The display control circuit 20 receives an input signal Sin including image information representing an image to be displayed and timing control information for image display from the outside of the organic EL display device 1, and, on the basis of the input signal Sin, outputs various control signals to the data signal line driving circuit 30, the demultiplexer unit 40, the scanning signal line driving circuit 50, and the light emission control line driving circuit 60. More specifically, the display control circuit 20 outputs a data start pulse DSP, a data clock signal DCK, display data DA, and a latch pulse LP to the data signal line driving circuit 30. The display control circuit 20 also outputs an A selection control signal SSDa and a B selection control signal SSDb to the demultiplexer unit 40. The display control circuit 20 also outputs a scan start pulse SSP and a scan clock signal SCK to the scanning signal line driving circuit 50. The display control circuit 20 also outputs a light emission control start pulse ESP and a light emission control clock signal ECK to the light emission control line driving circuit 60.

The data signal line driving circuit 30 includes an m-bit shift register, a sampling circuit, a latch circuit, m D/A converters, and the like (not illustrated). The shift register includes m bistable circuits cascade-connected to each other, transfers the data start pulse DSP supplied to the first stage in synchronization with the data clock signal DCK, and outputs a sampling pulse from each stage. Display data DA is supplied to the sampling circuit in accordance with the output timing of the sampling pulse. The sampling circuit stores the display data DA according to the sampling pulse. When display data DA for one row is stored in the sampling circuit, the display control circuit 20 outputs the latch pulse LP to the latch circuit. Upon receiving the latch pulse LP, the latch circuit holds the display data DA stored in the sampling circuit. The D/A converters are provided corresponding to m output lines DO1 to DOm respectively connected to m output terminals Td1 to Tdm of the data signal line driving circuit 30, convert the display data DA held in the latch circuit into data signals being analog voltage signals, and supply the data signals to the output lines DO1 to DOm. In the organic EL display device 1 according to the present embodiment, since the SSD system is adopted, an A data signal and a B data signal are sequentially (time divisionally) supplied to each output line DOi. Here, the A data signal is a data signal to be applied to the data signal lines (hereinafter also referred to as “A data signal lines”) Da1 to Dam out of the 2 m data signal lines Dx1 to Dxm (x=a, b) in the display portion 10, and the B data signal is a data signal to be applied to the data signal lines (hereinafter also referred to as “B data signal lines”) Db1 to Dbm.

The demultiplexer unit 40 includes m demultiplexers 41 including first to m-th demultiplexers 41 respectively corresponding to the m output terminals Td1 to Tdm of the data signal line driving circuit 30. The input terminal of the i-th demultiplexer 41 is connected to a corresponding output terminal Tdi of the data signal line driving circuit 30 with the output line DOi therebetween (i=1 to m). The i-th demultiplexer 41 (i=1 to m) includes two output terminals, and these two output terminals are respectively connected to two data signal lines Dai and Dbi. The i-th demultiplexer 41 supplies the A data signal and the B data signal sequentially supplied from the output terminal Tdi of the data signal line driving circuit 30 via the output line DOi respectively to the A data signal line Dai and the B data signal line Dbi. The action of each demultiplexer 41 is controlled by the A selection control signal SSDa and the B selection control signal SSDb. Adopting such an SSD system allows the number of output lines connected to the data signal line driving circuit 30 to be halved. Thus, since the circuit scale of the data signal line driving circuit 30 is reduced, the manufacturing cost of the data signal line driving circuit 30 can be reduced.

The scanning signal line driving circuit 50 drives the n scanning signal lines S1 to Sn. More specifically, the scanning signal line driving circuit 50 includes a shift register, a buffer, and the like (not illustrated). The shift register sequentially transfers the scan start pulse SSP in synchronization with the scan clock signal SCK. The scanning signal being the output from each stage of the shift register is supplied to the corresponding scanning signal line Sj (j=1 to n) via the buffer. The 2 m pixel circuits 11 connected to the scanning signal line Sj are collectively selected with the scanning signal at a low level (active scanning signal).

The light emission control line driving circuit 60 drives the n light emission control lines E1 to En. More specifically, the light emission control line driving circuit 60 includes a shift register, a buffer, and the like (not illustrated). The shift register sequentially transfers the light emission control start pulse ESP in synchronization with the light emission control clock signal ECK. The light emission control signal being the output from each stage of the shift register is supplied to a corresponding light emission control line Ej (j=1 to n) via the buffer.

### 1.2 Connection Relationship Between Pixel Circuit and Various Wiring Lines

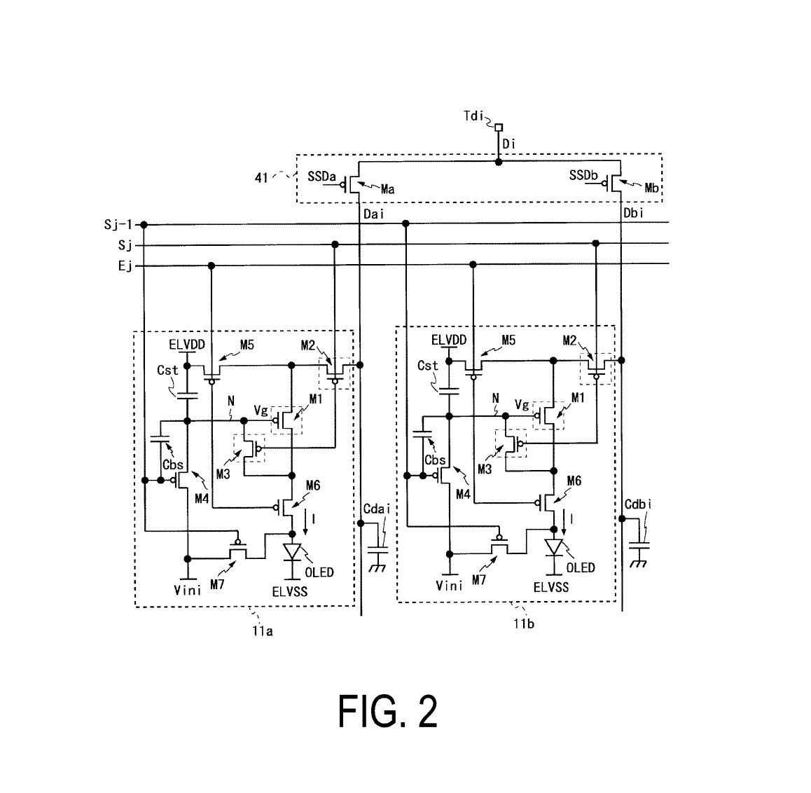

FIG. 2 is a circuit diagram illustrating a connection relationship between the pixel circuits 11a and 11b and various wiring lines included in the organic EL display device 1 of the present embodiment. Of the 2 m×n pixel circuits 11 in the display portion 10, these pixel circuits 11a and 11b are connected to the same scanning signal line Sj and are connected to the same demultiplexer 41 with the respective two data signal lines Dai and Dbi therebetween. Here, the reference numeral “11a” indicates the A pixel circuit connected to the A data signal line Dai, and the reference numeral “11b” indicates the B pixel circuit 11b connected to the B data signal line Dbi.

As illustrated in FIG. 2, each demultiplexer 41 includes an A selection transistor Ma and a B selection transistor Mb, and all of these selection transistors Ma and Mb function as switching elements. An A selection control signal SSDa is applied to the gate terminal as a control terminal of the A selection transistor Ma, and a B selection control signal SSDb is applied to the gate terminal as a control terminal of the B selection transistor Mb. The drain terminals of these selection transistors Ma and Mb are respectively connected to the data signal lines Dai and Dbi, and all of the source terminals are connected to the output line DOi (i=1 to m). Therefore, the output line DOi is connected to the A data signal line Dai with the A selection transistor Ma therebetween and connected to the B data signal line Dbi with the B selection transistor Mb therebetween in the corresponding demultiplexer 41.

As illustrated in FIG. 2, the A pixel circuit 11a and the B pixel circuit 11b are arranged in order in the extending direction of the scanning signal line Sj. Note that since the configurations of the A pixel circuit 11a and the B pixel circuit 11b are basically the same, in the following, the parts common to each other in these pixel circuits will be described by taking the configuration of the A pixel circuit 11a as an example, and the parts different from each other in these pixel circuits will be described individually as appropriate.

The A pixel circuit 11a includes the organic EL element OLED, the driving transistor M1, the writing transistor M2, the compensating transistor M3, the first initializing transistor M4, the power-supplying transistor M5, the light emission control transistor M6, the second initializing transistor M7, the storage capacitor for holding a data voltage (also referred to as a “second holding capacitor”) Cst, and a boost capacitor for coupling the node N and the previous scanning signal line Sj−1 (also referred to as a “first holding capacitor”) Cbs. Note that the B pixel circuit 11b also includes elements similar to those of the A pixel circuit 11a, and the connection relationship between the elements of the B pixel circuit 11b is also the same as that of the A pixel circuit 11a. Note that the storage capacitor Cst may be referred to as a “second holding capacitor”, and the boost capacitor Cbs may be referred to as a “first holding capacitor”.

To the A pixel circuit 11a, the scanning signal line Sj, the previous scanning signal line Sj−1, the light emission control line Ej, the A data signal line Dai, the high level power source line ELVDD, the low level power source line ELVSS, and the initialization power source line Vini are connected. To the B pixel circuit 11b, the B data signal line Dbi is connected in place of the A data signal line Dai. The other connections are the same as those of the A pixel circuit 11a. Note that as described above, a data signal line capacitor Cdai is formed at the A data signal line Dai, and a data signal line capacitor Cdbi is formed at the B data signal line Dbi (see the drawing).

In the A pixel circuit 11a, the gate terminal of the writing transistor M2 is connected to the scanning signal line Sj, and the source terminal of the writing transistor M2 is connected to the data signal line Dai. In the B pixel circuit 11b, the gate terminal of the writing transistor M2 is connected to the scanning signal line Sj, and the source terminal of the writing transistor M2 is connected to the data signal line Dbi.

In each of the A pixel circuit 11a and the B pixel circuit 11b, the writing transistor M2 supplies the voltage of the data signal line Dxi, that is, the data voltage held in the data signal line capacitor Cdxi to the driving transistor M1 when the scanning signal line Sj (x=a, b) is selected.

The first conducting terminal of the driving transistor M1 is connected to the drain terminal of the writing transistor M2. The driving transistor M1 supplies a drive current I corresponding to a source-gate voltage Vgs to the organic EL element OLED.

The compensating transistor M3 is provided between the gate terminal and the second conducting terminal of the driving transistor M1. The gate terminal of the compensating transistor M3 is connected to the scanning signal line Sj. The compensating transistor M3 brings the driving transistor M1 to a diode connection state when the scanning signal line Sj is selected.

The first initializing transistor M4 includes a gate terminal connected to the previous scanning signal line Sj−1 and is provided between the gate terminal of the driving transistor M1 and the initialization power source line Vini. The first initializing transistor M4 is brought into an on state when the previous scanning signal line Sj−1 changes from a high level to a low level and initializes the gate voltage Vg of the driving transistor M1. In addition, the second initializing transistor M7 includes a gate terminal connected to the previous scanning signal line Sj−1 and is provided between the anode of the organic EL element OLED and the initialization power source line Vini. The second initializing transistor M7 initializes the anode voltage of the organic EL element OLED when the previous scanning signal line Sj−1 is selected. Thus, the non-uniformity of luminance due to the influence of the previous frame image is reduced.

The power-supplying transistor M5 includes a gate terminal connected to the light emission control line Ej and is provided between the high level power source line ELVDD and the first conducting terminal of the driving transistor M1. The power-supplying transistor M5 supplies the high level power source voltage ELVDD to the source terminal as the first conducting terminal of the driving transistor M1 when the light emission control line Ej is selected.

The light emission control transistor M6 includes a gate terminal connected to the light emission control line Ej and is provided between the drain terminal as the second conducting terminal of the driving transistor M1 and the anode of the organic EL element OLED. The light emission control transistor M6 transmits the drive current I to the organic EL element OLED when the light emission control line Ej is selected.

One terminal of the storage capacitor Cst is connected to the gate terminal of the driving transistor M1 with the node N therebetween, and the other terminal is connected to the high level power source line ELVDD. The storage capacitor Cst is charged with the voltage of the data signal line Dxi (data voltage) when the scanning signal line Sj is in a select state, and the storage capacitor Cst holds the data voltage written by charging when the scanning signal line Sj is in a non-select state, thus maintaining the gate voltage Vg of the driving transistor M1.

One terminal of the boost capacitor Cbs is connected to the gate terminal of the driving transistor M1 with the node N therebetween, and the other terminal is connected to the previous scanning signal line Sj−1. When the potential of the previous scanning signal line Sj−1 changes from a high level to a low level, the first initializing transistor M4 is brought into an on state, and the node N is connected to initialization power source line Vini. Thus, the potential of the node N decreases toward the initialization potential Vini. Furthermore, when the previous scanning signal line Sj−1 to which the other terminal of the boost capacitor Cbs is connected changes to a low level, the potential of the one terminal is lowered by the boost capacitor Cbs, and the potential of the node N is also lowered. Thus, when the first initializing transistor enters an on state, the node N is connected to the initialization power source line Vini and is also lowered by the boost capacitor Cbs. This boost capacitor Cbs allows the gate voltage Vg of the driving transistor M1 to be rapidly brought close to the initialization potential Vini.

In addition, at the end of the scanning select period during which the data voltage is written into the storage capacitor Cst, the potential of the previous scanning signal line Sj−1 changes from a low level to a high level. At this time, since the potential of the other terminal of the boost capacitor Cbs connected to the previous scanning signal line Sj−1 changing from a low level to a high level pushes up the potential of the one terminal by the voltage difference between the low level voltage and the high level voltage, the potential of the node N also rises by the voltage difference. Thus, the provided boost capacitor Cbs allows the gate voltage of the driving transistor M1 to be further boosted from the data voltage by the voltage difference. Thus, it is possible to further reduce the drive current I supplied to the organic EL element OLED. This allows the image with black luminance to be easily displayed and can provide the improved contrast ratio of the image.

At this time, strictly speaking, the electric charge corresponding to the data voltage held in the data signal line capacitor Cd is redistributed to the data signal line capacitor Cd and the storage capacitor Cst, whereby the voltage held in the storage capacitor Cst becomes lower than the data voltage. However, since the capacitance of the data signal line capacitor Cd is sufficiently larger than the capacitance of the storage capacitor Cst, the reduction in the gate voltage Vg due to the charge redistribution can be neglected.

The organic EL element OLED includes an anode connected to the second conducting terminal of the driving transistor M1 with the light emission control transistor M6 therebetween and a cathode connected to the low level power source line ELVSS. Through the organic EL element OLED, the drive current I supplied from the driving transistor M1 when the light emission transistor M6 is brought into an on state flows, and the organic EL element OLED emits light with the luminance corresponding to the current value of the drive current I.

### 1.3 Arrangement of Capacitors

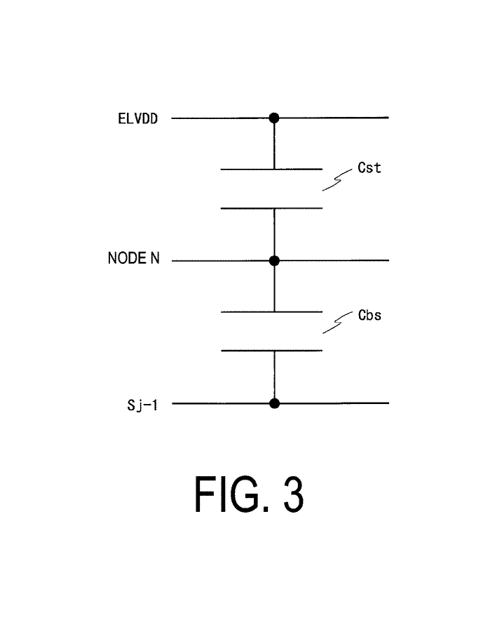

FIG. 3 is a diagram illustrating a positional relationship between the storage capacitor Cst and the boost capacitor Cbs disposed in each of the pixel circuits 11a and 11b. Each of the storage capacitor Cst and the boost capacitor Cbs may be formed on the insulating substrate. However, as illustrated in FIG. 3, the storage capacitor Cst may be formed on an insulating film formed on the upper face of the boost capacitor Cbs. Layering the capacitors allows the occupied area to be reduced so that the pixel circuits 11a and 11b can be made small. Thus, the resolution of the organic EL display device can be increased. Note that in FIG. 3, the storage capacitor Cst is formed on the insulating film formed on the upper face of the boost capacitor Cbs, but the boost capacitor Cbs may be formed on an insulating film formed on the upper face of the storage capacitor Cst.

### 1.4 Driving Method

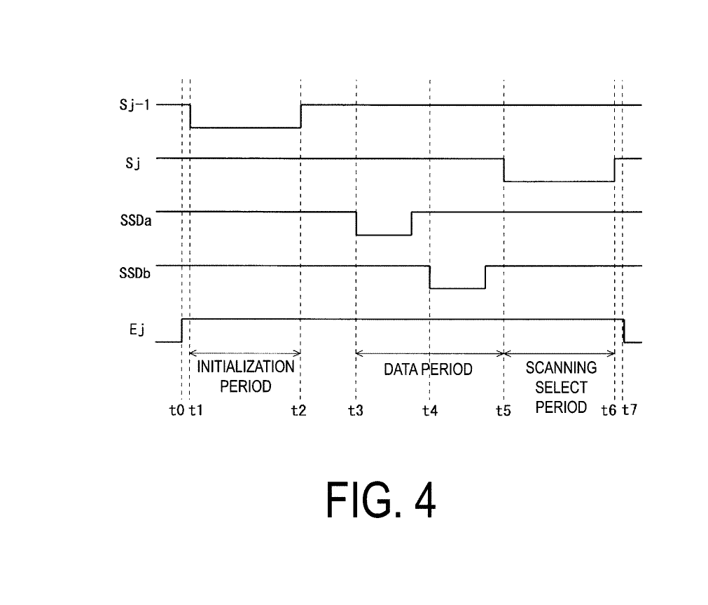

The drive of the driving method of the organic EL display device 1 according to the present embodiment will be described with reference to FIGS. 2 and 4. FIG. 4 is a timing chart for describing a driving method of each of the pixel circuits 11a and 11b illustrated in FIG. 2. That is, the two pixel circuits 11a and 11b are focused in FIG. 4 that are connected to the same scanning signal line Sj and connected to the same demultiplexer 41 respectively with the two data signal lines Dai and Dbi therebetween, and FIG. 4 is a drawing illustrating a timing chart for driving these pixel circuits 11a and 11b. Note that a circuit element such as a transistor in the pixel circuits 11a and 11b described below acts similarly in any of these pixel circuits 11a and 11b unless otherwise specified.

As illustrated in FIG. 4, at the time t0, the voltage of the light emission control line Ej changes from a low level to a high level. At the time t1, the voltage of the previous scanning signal line Sj−1 changes from a high level to a low level (active), and the initialization period during which the potential of the node N of the current scanning signal line is initialized starts. During this initialization period, the first initializing transistor M4 including the gate terminal connected to the previous scanning signal line Sj−1 is brought into an on state, and the node N is connected to the initialization power source line Vini. Furthermore, since a low level voltage is also applied to the other terminal of the boost capacitor Cbs, the potential of the node N connected to the one terminal is lowered by the boost capacitor Cbs. Therefore, the potential of the node N is lowered to the initialization voltage Vini in a short period of time. Thus, the gate voltage Vg of the driving transistor M1 reaches the initialization voltage Vini and is initialized. The initialization voltage Vini is such a voltage that the voltage can keep the driving transistor M1 in an on state during the writing of the data voltage into the pixel circuit. More specifically, the initialization voltage Vini may be a voltage satisfying the following relationship (1).

Vini−Vdata<−Vth (1),

where Vdata is the data voltage, and Vth (>0) is the threshold voltage of the driving transistor M1. This initialization action allows the potential of the node N to be reduced to the initialization voltage Vini in a short time and the data voltage to be reliably written into the pixel circuit.

In addition, at the time t0, the voltage of the light emission control line Ej changes from a low level to a high level. Thus, in the pixel circuits 11a and 11b, the power-supplying transistor M5 and the light emission control transistor M6 change to an off state. As a result, the drive current I is not supplied from the driving transistor M1 to the organic EL element OLED, and the organic EL element OLED is brought into a non-emitting state.

Note that at the time t1, the voltage of the previous scanning signal line Sj−1 changes from a high level to a low level, whereby the second initializing transistor M7 also enters an on state. As a result, the anode voltage of the organic EL element OLED is initialized. Since the initialization action by this second initializing transistor M7 is not directly related to the disclosure, its description will be omitted below.

At the time t2, the voltage of the previous scanning signal line Sj−1 changes from a low level to a high level, which causes the initialization period for initializing the potential of the node N to end and the previous scanning signal line Sj−1 to enter a non-select state. Therefore, the first initializing transistor M4 enters an off state. Thereafter, during the period from the time t3 to t5, the A selection control signal SSDa and the B selection control signal SSDb become a low level for the respective predetermined periods in this order. Thus, the A selection transistor Ma and the B selection transistor Mb in the demultiplexer 41 are sequentially brought into an on state for the respective predetermined periods. On the other hand, from the output terminal Tdi of the data signal line driving circuit 30, during the period from the time t3 to t5, the A data signal and the B data signal are sequentially output in conjunction with the A selection control signal SSDa and the B selection control signal SSDb (hereinafter, the period during which the data signal is output from the data signal line driving circuit 30, such as the period from the time t3 to t5, is referred to as “data period”). The voltages (data voltages) corresponding to these A data signal and B data signal sequentially output are respectively supplied to the data signal lines Dai and Dbi through the demultiplexer 41, and are respectively held in the data signal line capacitors Cdai and Cdbi. Note that at the time t4, before the B selection control signal SSDb changes from a high level to a low level, the A selection control signal SSDa changes from a low level to a high level.

At the time t5 being the end time of the data period, all of the selection transistors Ma and Mb are in an off state, the voltage of the A data signal line Dai is maintained at a voltage corresponding to the A data signal by the data signal line capacitor Cdai, and the voltage of the B data signal line Dbi is maintained at a voltage corresponding to the B data signal by the data signal line capacitor Cdbi. In addition, at the time t5, the voltage of the scanning signal line Sj changes from a high level to a low level. Therefore, the writing transistor M2 and the compensating transistor M3 are brought into an on state. Thus, the voltage held in the data signal line capacitor Cdai of the A data signal line Dai (corresponding to a voltage corresponding to the A data signal, hereinafter referred to as “A data voltage VdA”) is supplied to the gate terminal of the driving transistor M1 via the writing transistor M2, the driving transistor M1, and the compensating transistor M3 in the A pixel circuit 11a. At this time, the drain terminal as the second conducting terminal and the gate terminal as the control terminal of the driving transistor M1 are electrically connected to each other, whereby the driving transistor M1 enters a diode connection state. While the driving transistor M1 is in the diode connection state, the gate voltage Vg of the driving transistor changes toward the value given by the following equation (2).

Vg=Vdata−Vth (2),

provided that Vdata equals to VdA. Strictly speaking, since the electric charge held in the data signal line capacitor Cdai is redistributed to the data signal line capacitor Cdai and the storage capacitor Cst, the voltage actually supplied to the gate terminal of the driving transistor M1 may be lower than the gate voltage Vg given by the above equation (2). Note that since the capacitance of each data signal line capacitor Cdxi (x=a, b) is sufficiently greater than the capacitance of the storage capacitor Cst in each pixel circuit 11x, in the following, the reduction in the gate voltage Vg due to charge redistribution is assumed to be negligible.

In addition, at the time t5, when the voltage of the scanning signal line Sj changes from a high level to a low level, the voltage held in the data signal line capacitor Cdbi of the B data signal line Dbi (corresponding to a voltage corresponding to the B data signal, hereinafter referred to as “B data voltage VdB”) is supplied to the gate terminal of the driving transistor M1 via the writing transistor M2, the driving transistor M1, and the compensating transistor M3 in the B pixel circuit 11b. Therefore, also in the B pixel circuit 11b, the circuit element such as a transistor inside it acts similarly to the circuit element in the A pixel circuit 11a, and the gate voltage Vg of the driving transistor changes toward the value given by the above equation (2) (provided that Vdata equals to VdB).

The supply of the A data voltage VdA to the gate terminal of the driving transistor M1 in the A pixel circuit 11a and the supply of the B data voltage VdB to the gate terminal of the driving transistor M1 in the B pixel circuit 11b continue during the period when the voltage of the scanning signal line Sj is at a low level, that is, the scanning select period t5 to t6 in which the scanning signal line Sj is in a select state. As a result, in the scanning select period t5 to t6, the storage capacitor Cst in each pixel circuit 11x is charged with the voltage of the data signal line Dxi (x=a, b) (data voltage). Thus, the voltage corresponding to the data voltage is written into the storage capacitor Cst of the pixel circuit 11 as gray scale data.

At the time t6, the voltage of the scanning signal line Sj changes from a low level to a high level, and the scanning select period ends. Therefore, in each of the A pixel circuit 11a and the B pixel circuit 11b, the writing transistor M2 and the compensating transistor M3 are brought into an off state.

At the time t7, the voltage of the light emission control line Ej changes from a high level to a low level. Therefore, in each of the A pixel circuit 11a and the B pixel circuit 11b, the power-supplying transistor M5 and the light emission control transistor M6 change into an on state. Thus, the drive current I corresponding to the gate voltage Vg of the driving transistor M1 and the high level power source line ELVDD, that is, the drive current I corresponding to the voltage held in the storage capacitor Cst, is supplied to the organic EL element OLED, and the organic EL element OLED emits light according to the current value of the drive current I. As described above, the action from the time t1 to the time t6 is repeated n times in one frame period, whereby an image for one frame is displayed.

### 1.5 Effect

According to the organic EL display device 1 of the present embodiment, the boost capacitor Cbs including one terminal connected to the node N and the other terminal connected to the previous scanning signal line Sj−1 is disposed. When the voltage of the previous scanning signal line Sj−1 changed from a low level to a high level is applied to the other terminal of the boost capacitor Cbs charged by the data voltage in the scanning select period, the gate voltage of the driving transistor M1 is pushed up by the boost capacitor Cbs and rises from the data voltage by the amount of the voltage difference between the voltage at a low level and the voltage at a high level applied by the previous scanning signal line Sj−1. Thus, the gate voltage of the driving transistor M1 is boosted by the amount of the voltage difference, so that the drive current I flowing through the organic EL element OLED can be controlled to be small. This allows the image with black luminance to be easily displayed and can provide the improved contrast ratio of the image.

In addition, when the first initializing transistor M4 is brought into an on state during the initialization period, and the node N is connected to the initialization power source line Vini, the potential of the node N is lowered. Furthermore, since the level of the voltage applied to the second terminal of the boost capacitor Cbs charged in the previous scanning select period changes from a high level to a low level, the potential of the node N is also lowered. Thus, the potential of the node N decreases in a short period toward the initialization potential Vini. Therefore, the data voltage is written into the storage capacitor Cst in the scanning select period, and the organic EL display device 1 can display an image having luminance corresponding to the data signal.

In addition, the data voltage is not only held in the storage capacitor Cst, but also held in the boost capacitor Cbs at the same time. The function of this boost capacitor Cbs is a function not found in the auxiliary capacitor Cau described as the related art, and the provided boost capacitor Cbs allows the data voltage to be more reliably held in the pixel circuits 11a and 11b.

In addition, since the data voltage is held not only in the storage capacitor Cst but also in the boost capacitor Cbs, the capacitance holding the data voltage increases. As a result, the fluctuation of the potential of the node N due to the parasitic capacitor formed at the node N can be almost ignored. This provides the same effect as that obtained by increasing the capacitance of the storage capacitor Cst.

Furthermore, a layered structure may be used in which the storage capacitor Cst and the boost capacitor Cbs are layered with an insulating film interposed therebetween. Layering these capacitors allows the occupied area to be reduced so that the pixel circuits 11a and 11b can be made small. Thus, the resolution of the organic EL display device can be increased. In addition, making these capacitors a layered structure allows the sum of the capacitance of the storage capacitor Cst and the capacitance of the boost capacitor Cbt to be increased in a small occupied area.

### 1.6 Modified Example

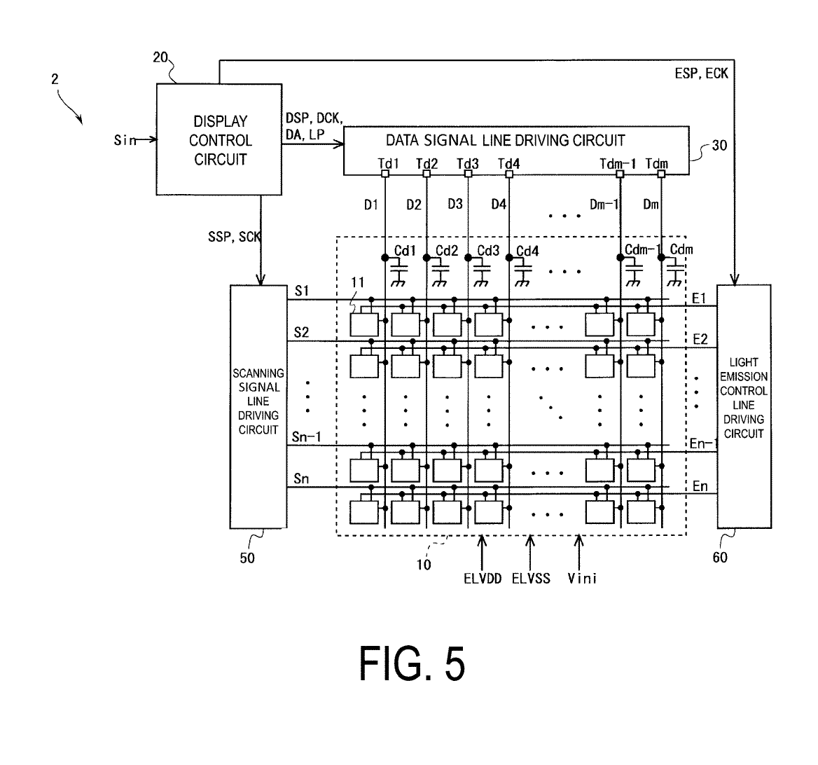

An organic EL display device 2 according to a modified example of the present embodiment will be described. FIG. 5 is a block diagram illustrating an overall configuration of the organic EL display device 2 according to the present modified example. As illustrated in FIG. 5, unlike the organic EL display device 1 illustrated in FIG. 1, the organic EL display device 2 does not include the demultiplexer unit 40. Therefore, the m data signal lines D1 to Dm are respectively directly connected to the m output terminals Td1 to Tdm of the data signal line driving circuit 30. The other configuration is the same as the configuration of the organic EL display device 1 illustrated in FIG. 1, and its description will be omitted.

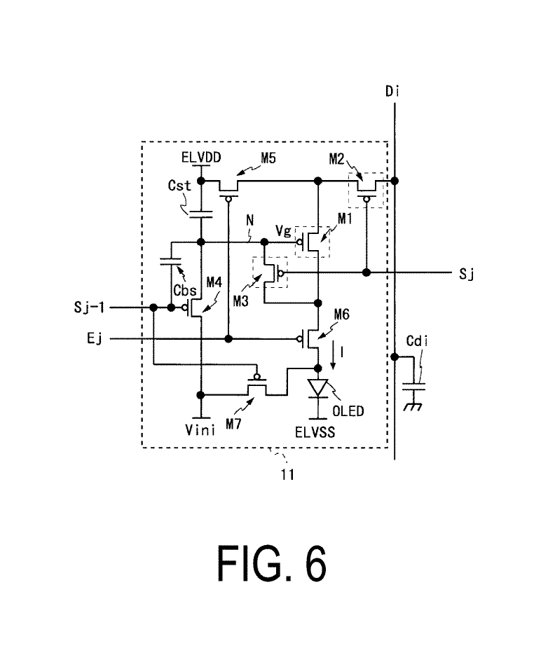

FIG. 6 is a circuit diagram illustrating a configuration of a pixel circuit 11 included in the organic EL display device 2. As illustrated in FIG. 6, since the configuration of the pixel circuit 11 is the same as the configuration of the pixel circuits 11a and 11b illustrated in FIG. 2, the description thereof will be omitted.

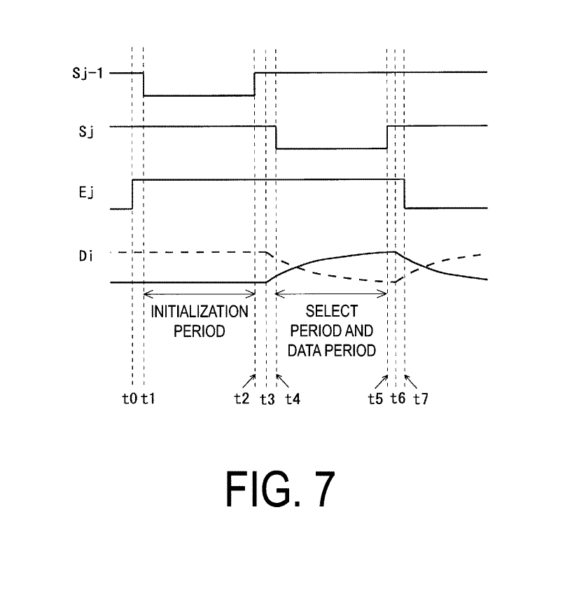

In the following, the driving method of the organic EL display device 2 according to the present modified example will be described with reference to FIGS. 6 and 7. FIG. 7 is a diagram illustrating a timing chart for driving the pixel circuit 11 connected to the scanning signal line Sj and a data signal line Di. At the time t0, the light emission control line Ej changes from a low level to a high level. Furthermore, from the time t1 to the time t2, the potential of the previous scanning signal line Sj−1 changes from a high level to a low level, whereby the first initializing transistor M4 is brought into an on state, and the potential of the node N is initialized to the initialization potential Vini. At this time, since the potential of the node N is lowered by the boost capacitor Cbs as in the case of the first embodiment, the potential of the node N reaches the initialization potential Vini in a short time.

During the period from the time t3 to the time t6, a data signal is output to the data signal line Di. Furthermore, at the time t4, the potential of the scanning signal line Sj changes from a high level to a low level. Thus, the data signal supplied from the data signal line Di is written into the storage capacitor Cst via the writing transistor M2, the driving transistor M1, and the compensating transistor M3. Thereafter, at the time t5, when the potential of the scanning signal line Sj changes from a low level to a high level, the writing of the data signal into the storage capacitor Cst ends, and the data signal is held in the storage capacitor Cst. Thus, the data period and the scanning select period end.

Furthermore, at the time t7, the voltage of the light emission control line Ej changes from a high level to a low level, and the light emission control transistor M6 is brought into an on state. Thus, a drive current controlled by the driving transistor M1 flows through the organic EL element OLED, and the organic EL element OLED emits light with luminance corresponding to the data signal.

As described above, according to the present modified example, as in the organic EL display device 1 according to the first embodiment, also in the organic EL display device 2 not adopting the SSD system, the data voltage is written into the boost capacitor Cbs in the scanning select period in which the scanning signal line Sj is in a select state, and the organic EL display device 2 can display an image having luminance corresponding to the data signal.

### 2. Second Embodiment

Since the block diagram illustrating the overall configuration of the organic EL display device according to the present embodiment is the same as the block diagram of the overall configuration of the organic EL display device 1 illustrated in FIG. 1, the block diagram of the overall configuration and the description thereof will be omitted. Note that in the present embodiment, “12” is used as a reference numeral of the pixel circuit illustrated in FIG. 1.

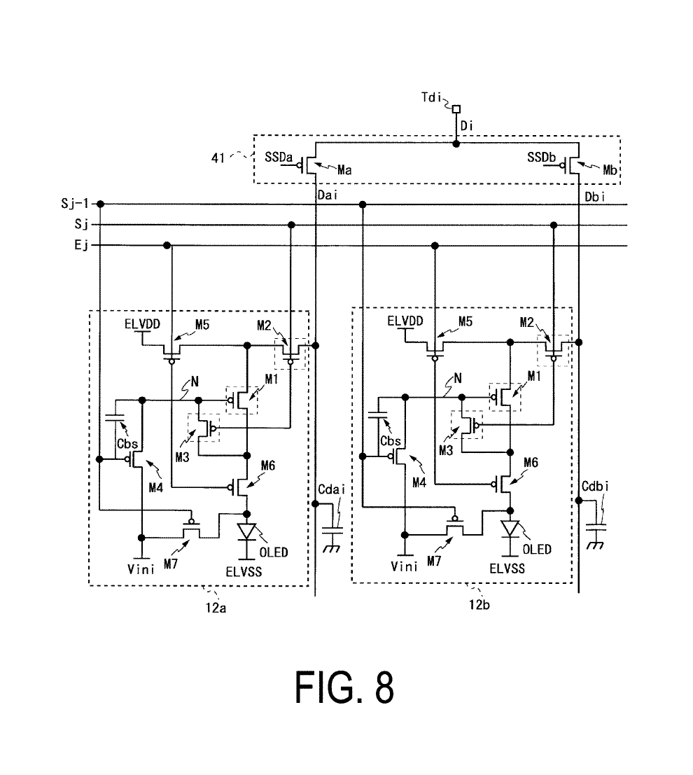

FIG. 8 is a circuit diagram illustrating a connection relation between the pixel circuits 12a and 12b and various wiring lines included in the organic EL display device according to the present embodiment. As illustrated in FIG. 8, in the circuit diagram illustrating the connection relation between the pixel circuits 12a and 12b and various wiring lines in the present embodiment, the same portions as those in the circuit diagram illustrating the connection relation between the pixel circuits 11a and 11b and various wiring lines in the above embodiment will not be described, and different portions will be described.

The configuration of the demultiplexer unit 40 to which the respective data signal lines Dai and Dbi of the pixel circuits 12a and 12b are connected is the same as the configuration of the demultiplexer unit 40 illustrated in FIG. 2, and the description thereof will be omitted. In addition, the seven transistors M1 to M7 and the connection relationship thereof included in each of the pixel circuits 12a and 12b are also the same as the case in the pixel circuits 11a and 11b illustrated in FIG. 2, so that the description thereof will be omitted.

In the pixel circuits 12a and 12b of the present embodiment, the storage capacitor Cst is not provided out of the two types of capacitors illustrated in FIG. 2, and only the boost capacitor Cbs including one terminal connected to the node N and the other terminal connected to the previous scanning signal line Sj−1 is provided. Therefore, as in the boost capacitor Cbs of the first embodiment, when the potential of the previous scanning signal line Sj−1 changes from a high level to a low level, the boost capacitor Cbs of the present embodiment lowers the potential of the node N to reduce the time for initializing the node N, and, when the potential of the previous scanning signal line Sj−1 changes from a low level to a high level, the boost capacitor Cbs pushes up the potential of the node N. This allows the pixel circuits to easily display the image having black luminance. Furthermore, the boost capacitor Cbs of the present embodiment also functions as a storage capacitor that holds a data voltage written into the node N from each of the data signal lines Dai and Dbi via the writing transistor M2 and the compensating transistor M3. Thus, the data voltage held in the boost capacitor Cbs is applied to the gate terminal of the driving transistor Mt, whereby the drive current I flowing through the organic EL element OLED is controlled, and the light emission luminance of the organic EL element OLED is controlled.

In this way, the boost capacitor Cbs also functions as the storage capacitor Cst. Therefore, even in a case where the storage capacitor Cst is not provided, the data voltage is held in the boost capacitor Cbs. This allows the driving transistor M1 to control the drive current I flowing through the organic EL element OLED and to control the light emission luminance of the organic EL element OLED. Thus, the configuration of the pixel circuits 12a and 12b can be simplified and the manufacturing cost of the organic EL display device can be reduced.

### 2.1 Modified Example

The organic EL display device 2 according to a modified example of the present embodiment will be described. Since the block diagram illustrating the overall configuration of the organic EL display device according to the present modified example is the same as the block diagram of the overall configuration of the organic EL display device 2 illustrated in FIG. 5, the block diagram of the overall configuration and the description thereof will be omitted.

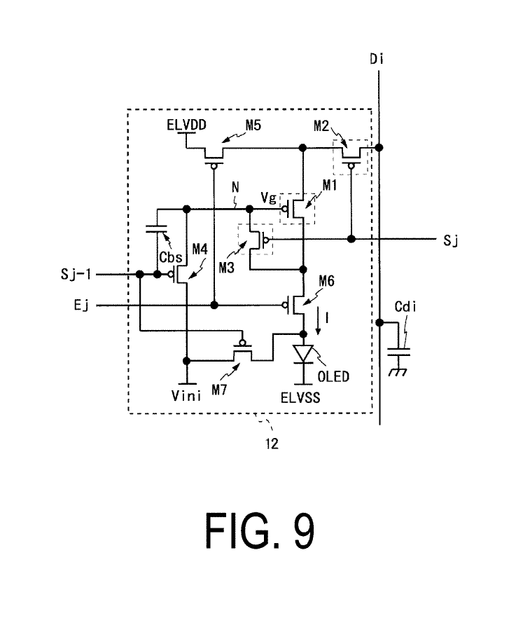

FIG. 9 is a circuit diagram illustrating a configuration of a pixel circuit 12 included in the organic EL display device 2. As illustrated in FIG. 9, unlike the pixel circuit 11 illustrated in FIG. 6, the pixel circuit 12 is provided with the boost capacitor Cbs, but not provided with the storage capacitor Cst. In addition, since the pixel circuit 12 is driven on the basis of the above timing chart illustrated in FIG. 7, the description of the driving method thereof will be omitted. Thus, according to the present modified example, as in the organic EL display device 2 according to the second embodiment, also in the organic EL display device 2 not adopting the SSD system, the data voltage is written into the boost capacitor Cbs in the scanning select period in which the scanning signal line Sj is brought into a select state, and the organic EL display device 2 can display an image having luminance corresponding to the data signal.

### 3. Supplementary Note

### 3.1 Supplementary Note 1

A display device described in Supplementary Note 1 is a display device including a plurality of data signal lines configured to transmit a plurality of data signals representing an image to be displayed, a plurality of scanning signal lines intersecting the plurality of data signal lines, and a plurality of pixel circuits arranged in a matrix shape along the plurality of data signal lines and the plurality of scanning signal lines, the display device including:

a data signal line driving circuit including a plurality of output terminals corresponding to a plurality of respective sets of data signal line groups obtained by grouping the plurality of data signal lines with a predetermined number not less than two of data signal lines as one set, the data signal line driving circuit being configured to output, from an output terminal of the plurality of output terminals, a predetermined number of data signals to be transmitted in a time division manner, via a predetermined number of data signal lines of a set corresponding to the output terminal;

a selection output circuit including a plurality of demultiplexers connected to the plurality of respective output terminals of the data signal line driving circuit, the plurality of demultiplexers corresponding to the plurality of respective sets of data signal line groups; and

a scanning signal line driving circuit configured to selectively drive the plurality of scanning signal lines.

Each of the plurality of pixel circuits corresponds to any one of the plurality of data signal lines and corresponds to any one of the plurality of scanning signal lines.

Each of the plurality of pixel circuits includes a display element configured to be driven by a current, a holding capacitor configured to hold a voltage for controlling a drive current of the display element, a driving transistor configured to apply a drive current corresponding to a voltage held in the holding capacitor to the display element, and an initializing transistor configured to initialize a potential of a control terminal of the driving transistor, and each of the plurality of pixel circuits has a configuration in which in a case that a corresponding scanning signal line is in a select state, the driving transistor is brought into a diode connection state and a voltage of a corresponding data signal line is applied to the holding capacitor via the driving transistor, and in a case that a corresponding previous scanning signal line is in a select state, a potential of a control terminal of the driving transistor is initialized via the initializing transistor.

The holding capacitor includes a first holding capacitor including one terminal connected to the control terminal of the driving transistor and the other terminal connected to the previous scanning signal line.

### 3.2 Supplementary Note 2

The display device described in Supplementary note 2 may have a configuration in which the holding capacitor further includes a second holding capacitor including one terminal connected to the control terminal of the driving transistor and the other terminal connected to a power source line configured to supply a voltage at a high level to a conducting terminal of the driving transistor. According to the display device described in Supplementary note 2 described above, when the voltage of the previous scanning signal line changes from a low level to a high level, the voltage of the control terminal of the driving transistor is pushed up by the first holding capacitor and rises from the data voltage by the amount of the voltage difference between the voltage at a low level and the voltage at a high level. Thus, since the voltage of the control terminal is boosted by the amount of the voltage difference, the control is possible such that the drive current flowing through the display element further reduces. This allows the image with black luminance to be easily displayed and can provide the improved contrast ratio of the image. In addition, when the initializing transistor is brought into an on state during the initialization period, and the control terminal of the driving transistor is connected to the initialization power source line, the potential of the control terminal is initialized. Furthermore, the level of the voltage applied to the second terminal of the first holding capacitor changes from a high level to a low level, the potential of the control terminal is also lowered. Thus, the potential of the control terminal of the driving transistor decreases in a short period toward the initialization potential. Therefore, the data voltage is written into the first and second holding capacitors in the scanning select period in which the scanning signal line is brought into a select state, and the organic EL display device can display an image having luminance corresponding to the data signal.

### 3.3 Supplementary Note 3

The display device described in Supplementary note 3 may have a configuration in which the first holding capacitor and the second holding capacitor are layered on an insulating substrate. According to the display device described in Supplementary note 3 described above, layering the first holding capacitor and the second holding capacitor allows the occupied area to be reduced so that the pixel circuits can be made small. Furthermore, the capacitors having a layered structure allows the sum of the capacitance of the storage capacitor Cst and the capacitance of the boost capacitor Cbt to be increased in a small occupied area.

### 3.4 Supplementary Note 4

In the display device described in Supplementary note 4, the data signal line driving circuit may include a plurality of output terminals corresponding to a plurality of respective sets of data signal line groups obtained by grouping the plurality of data signal lines, with a predetermined number not less than two of data signal lines as one set, and the data signal line driving circuit may output, from an output terminal of the plurality of output terminals, a predetermined number of data signals to be transmitted in a time division manner, via a predetermined number of data signal lines of a set corresponding to the output terminal, and the display device may further include a selection output circuit including a plurality of demultiplexers connected to the plurality of respective output terminals of the data signal line driving circuit, the plurality of demultiplexers corresponding to the plurality of respective sets of data signal line groups. According to the display device described in Supplementary note 4, even in the display device not adopting the SSD system, as in the display device adopting the SSD system, in the scanning select period in which the scanning signal line is brought into a select state, the data voltage is written into the first holding capacitor, and the display device can display an image having luminance corresponding to the data signal.

### REFERENCE SIGNS LIST

1, 2 Organic EL display device
10 Display portion
11, 11x, 12, 12x Pixel circuit (x=a, b)
20 Display control circuit
30 Data signal line driving circuit
40 Demultiplexer unit (selection output circuit)
41 Demultiplexer
50 Scanning signal line driving circuit
60 Light emission control line driving circuit
Tdi Output terminal (i=1 to m)
DOi Output line (i=1 to m)
Dai, Dbi Data signal line
Sj Scanning signal line (j=1 to n)
Ej Light emission control line (j=1 to n)
Cdai, Cdbi Data signal line capacitor (i=1 to m)
Cdi Data signal line capacitor (i=1 to m)
Ma, Mb Selection transistor (switching element)
M1 Driving transistor
M2 Writing transistor
M3 Compensating transistor
M4 First initializing transistor
M5 Power-supplying transistor
M6 Light emission control transistor
M7 Second initializing transistor
Cst Storage capacitor (second holding capacitor)
Cbs Boost capacitor (first holding capacitor)
OLED Organic EL element (display element)
SSDx Selection control signal (x=a, b)

1. A display device including a plurality of data signal lines configured to transmit a plurality of data signals representing an image to be displayed, a plurality of scanning signal lines intersecting the plurality of data signal lines, and a plurality of pixel circuits arranged in a matrix shape along the plurality of data signal lines and the plurality of scanning signal lines, the display device comprising:
a data signal line driving circuit configured to output the plurality of data signals to the respective plurality of data signal lines; and
a scanning signal line driving circuit configured to selectively drive the plurality of scanning signal lines,
wherein each of the plurality of pixel circuits corresponds to any one of the plurality of data signal lines and corresponds to any one of the plurality of scanning signal lines,
each of the plurality of pixel circuits includes a display element configured to be driven by a current, a holding capacitor configured to hold a voltage for controlling a drive current of the display element, a driving transistor configured to apply a drive current corresponding to a voltage held in the holding capacitor to the display element, and an initializing transistor configured to initialize a potential of a control terminal of the driving transistor, and each of the plurality of pixel circuits has a configuration in which in a case that a corresponding scanning signal line is in a select state, the driving transistor is brought into a diode connection state and a voltage of a corresponding data signal line is applied to the holding capacitor via the driving transistor, and in a case that a corresponding previous scanning signal line is in a select state, a potential of a control terminal of the driving transistor is initialized via the initializing transistor, and
the holding capacitor includes a first holding capacitor including one terminal connected to the control terminal of the driving transistor and the other terminal connected to the corresponding previous scanning signal line.

2. The display device according to claim 1,
wherein the holding capacitor further includes a second holding capacitor including one terminal connected to the control terminal of the driving transistor and the other terminal connected to a power source line configured to supply a voltage at a high level to a conducting terminal of the driving transistor.

3. The display device according to claim 2,
wherein the first holding capacitor and the second holding capacitor are layered on an insulating substrate.

4. The display device according to claim 1,
wherein the data signal line driving circuit includes a plurality of output terminals corresponding to a plurality of respective sets of data signal line groups obtained by grouping the plurality of data signal lines with a predetermined number not less than two of data signal lines of the plurality of data signal lines as one set, and outputs, from an output terminal of the plurality of output terminals, a predetermined number of data signals to be transmitted in a time division manner, via a predetermined number of data signal lines of a set corresponding to the output terminal, and
the display device further includes a selection output circuit including a plurality of demultiplexers connected to the plurality of respective output terminals of the data signal line driving circuit and corresponding to the plurality of respective sets of data signal line groups.
